(19) United States
(12) Patent Application Publication
(10) Pub. No.: US 2025/0268130 A1
(43) Pub. Date: Aug. 28, 2025

(54) TAPERED PIN CONNECTION AND ARTICULATING MOWER DECK WITH THE SAME

(71) Applicant: EXMARK MANUFACTURING COMPANY INCORPORATED, Beatrice, NE (US)

(72) Inventors: Brian F. Smidt, Beatrice, NE (US); Thomas M. Person, Plymouth, NE (US); C. Mark Atterbury, Hickman, NE (US)

(21) Appl. No.: 19/055,818

(22) Filed: Feb. 18, 2025

Related U.S. Application Data
(60) Provisional application No. 63/556,624, filed on Feb. 22, 2024.

(51) Int. Cl. A01D 34/66; A01D 34/64; F16C 11/04

(52) U.S. Cl. CPC A01D 34/661; F16C 11/04; A01D 34/64

(57) ABSTRACT

A ground working vehicle and a fold mechanism for coupling vehicle components are provided including a tapered pin connection with improved resistance to uneven or premature wear on and around the pin connection and related components. A tapered pin is configured to be disposed within respective frustoconical apertures of tapered bushings to compressively engage the first and second tapered bushings. Resistance to relative movement between the tapered pin and the tapered bushings is provided by force vectors both axially and normal to contact surfaces between the first and second frustoconical end portions of the tapered pin and the corresponding first and second tapered bushings.

The present application claims the benefit of U.S. Provisional Patent Application No. 63/556,624, filed Feb. 22, 2024. Each of the applications and patents listed in this paragraph is incorporated herein by reference in its entirety.

Embodiments of the present disclosure are directed to ground working vehicles, and more particularly, to a tapered pin connection for use in pivotally connecting vehicle components such as deck sections of an articulating mower deck.

### BACKGROUND

Large turf mowing machines have long been known for providing a high quality and efficient cut on relatively flat and unobstructed terrain. For example, the wide cutting swath typical of these mowers allows for productive cutting of large turf areas such as golf courses, sports fields, and the like. However, conventional large cutting decks may struggle to provide the same high quality of cut when mowing hilly or other highly contoured terrain.

To address this issue, articulating decks (i.e., decks that segment the cutting unit into two or more narrower cutting deck sections) are available. The deck sections are joined (e.g., pivotally) together to create a relatively wide cutting deck with individually movable (e.g., articulating) deck sections. As the individual sections are able to closely follow the terrain, articulating decks may provide a higher quality of cut over undulating terrain than a non-articulating deck of similar width.

### SUMMARY

Embodiments described herein may provide an articulating mower deck including: a center deck section, a wing deck section, and a fold mechanism with a fold link connecting the center deck section to the wing deck section. The fold mechanism includes: a fixed pivot connected to the center deck section, the fixed pivot defining a fixed pivot axis; first and second tapered bushings defining respective first and second at least partially frustoconical apertures having respective first and second tapered bushing taper angles, the first and second tapered bushings associated with the wing deck section; a wing pivot spaced apart from the fixed pivot and connected to the wing deck section, the wing pivot defining a wing pivot axis and having a sleeve positioned between (e.g., between interior faces of) the first and second tapered bushings; a deck arm extending between the fixed pivot and the wing pivot; a pin passing through the first and second tapered bushings and the sleeve; and a nut defining an at least partially frustoconical exterior surface having a nut taper angle corresponding to the first tapered bushing taper angle. The pin includes: a threaded first end portion, a second end portion defining a frustoconical shape having a pin taper angle corresponding to the second tapered bushing taper angle, and a center portion having a cylindrical outer diameter configured to be rotatably positioned within the sleeve. The nut is configured to threadably engage the first end portion.

The articulating mower deck may further include first and second lugs associated with the wing deck section. The first tapered bushing may be secured to an exterior face of the first lug and the second tapered bushing may be secured to an exterior face of the second lug. A spacer may extend between interior faces of the first and second lugs, the spacer configured to restrict movement of the first and second lugs relative to one another. The articulating mower deck may further include a resilient bushing securely received within the sleeve and disposed between (e.g., within the annular space between) the sleeve and the center portion of the pin. The resilient bushing may include a flange and may be securely received within the sleeve such that the flange abuts both the sleeve and the interior face of the first lug. The resilient bushing may be configured to be securely received within the sleeve via friction fit, a retaining compound, or a combination thereof. The resilient bushing may be, or include, plastic. The pin taper angle may be 3.5 degrees or between 2 and 10 degrees. The nut taper angle may be 45 degrees or between 10 and 60 degrees. The fixed pivot axis may be parallel to the wing pivot axis. The fold mechanism may further include a threadlocking compound between the nut and the threaded first end portion of the pin, a threadlocking device between the nut and the threaded first end portion of the pin, or a combination thereof.

In another embodiment, a kit to pivotally couple a wing deck section to a center deck section of an articulating mower deck is provided that includes: a first tapered bushing configured to be secured at an exterior face of a first lug of the wing deck section, the first tapered bushing defining an at least partially frustoconical aperture having a first tapered bushing taper angle; a second tapered bushing configured to be secured at an exterior face of a second lug of the wing deck section, the second tapered bushing defining an at least partially frustoconical aperture having a second tapered bushing taper angle; a resilient bushing configured to be securely received within a sleeve of a fold link pivotally connecting the wing deck section to the center deck section; a pin configured to pass through the first and second tapered bushings, the first and second lugs, and the resilient bushing; and a nut with an at least partially frustoconical exterior surface having a nut taper angle corresponding to the first tapered bushing taper angle. The pin includes: a threaded first end portion, a second end portion defining a frustoconical shape having a pin taper angle corresponding to the second tapered bushing taper angle, and a center portion having a cylindrical outer diameter configured to be rotatably positioned within the resilient bushing. The nut may be configured to threadably engage the first end portion.

The kit may further include a spacer configured to extend between interior faces of the first and second lugs and restrict movement of the first and second lugs relative to one another. The resilient bushing may be configured to be securely received within the sleeve via friction fit, a retaining compound, or a combination thereof. The resilient bushing may include a flange and may be configured to be securely received within the sleeve such that the flange abuts both the sleeve and an interior face of the first lug. The pin taper angle may be 3.5 degrees or between 2 and 10 degrees. The nut taper angle may be 45 degrees or between 10 and 60 degrees. The resilient bushing may be, or include, plastic.

In yet another embodiment, a pivot assembly to pivotally couple a first portion of a working vehicle to a second portion of the working vehicle may be provided that includes: first and second tapered bushings defining respective first and second at least partially frustoconical apertures having respective first and second tapered bushing taper angles, the first and second tapered bushings associated with the first portion of the working vehicle; a pivot connected to the first portion, the pivot defining a pivot axis and including a sleeve positioned between (e.g., between interior faces of) the first and second tapered bushings, the sleeve associated with the second portion of the working vehicle; a pin passing through the first and second tapered bushings and the sleeve; and a nut defining an at least partially frustoconical exterior surface having a nut taper angle corresponding to the first tapered bushing taper angle. The pin includes: a threaded first end portion; a second end portion defining a frustoconical shape having a pin taper angle corresponding to the second tapered bushing taper angle; and a center portion having a cylindrical outer diameter configured to be rotatably positioned within the sleeve. The nut is configured to threadably engage the first end portion.

In still yet another embodiment, an articulating mower deck may be provided that includes: a first deck section; a second deck section; and a pivot assembly connecting the first deck section to the second deck section. The pivot assembly includes: first and second tapered bushings defining respective first and second at least partially frustoconical apertures having respective first and second tapered bushing taper angles, the first and second tapered bushings associated with the first deck section; a sleeve associated with the second deck section and positioned between (e.g., between interior faces of) the first and second tapered bushings; and a pin disposed within the first and second tapered bushings and the sleeve, the pin configured to compressively engage the first and second tapered bushings. The pin includes: a first end portion defining a first frustoconical shape having a first pin taper angle corresponding to the first tapered bushing taper angle; a second end portion defining a second frustoconical shape having a second pin taper angle corresponding to the second tapered bushing taper angle; and a center portion between the first and second end portions configured to be rotatably positioned within the sleeve.

The first end portion may include a fastener engaged thereon, the fastener defining the first frustoconical shape having the first pin taper angle. The first end portion may include a nut threadably engaged thereon, the nut defining the first frustoconical shape having the first pin taper angle. The first end portion may be welded to the center portion.

The above summary is not intended to describe each embodiment or every implementation. Rather, a more complete understanding of illustrative embodiments will become apparent and appreciated by reference to the following Detailed Description of Illustrative Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 is a perspective view of a riding ground working vehicle configured as a zero-turn-radius (ZTR) lawn mower, the mower having a belly-mounted articulating mower deck in accordance with embodiments of the present disclosure, wherein the deck is shown in an operating configuration (corresponding to wing deck sections each being in an operating position);

FIG. 2 illustrates the mower of FIG. 1 with the deck shown in a folded (non-operating) configuration (corresponding to the wing deck sections each being in a folded position);

FIG. 3 is a bottom plan view of the articulating mower deck of FIG. 1 (in the operating configuration), wherein the deck includes a center deck section and two (i.e., left and right) single-spindle wing deck sections (various structure is removed from this and remaining figures to better illustrate aspects of the described embodiments);

FIG. 4 is an upper perspective view of the articulating mower deck of FIG. 3 (operating configuration) isolated from the mower;

FIG. 5 is an enlarged upper perspective view of an articulating mower deck in accordance with embodiments of the present disclosure illustrating aspects of a deck fold mechanism for connecting a wing deck section to a center deck section (again, some structure is removed from the deck in this and other views to better illustrate embodiments of this disclosure);

FIG. 6 illustrates a fold link isolated from the deck fold mechanism of FIG. 5;

FIG. 7 is an enlarged upper perspective view of a portion of an illustrative fold mechanism of the articulating mower deck of FIG. 3;

FIG. 8 is a lower perspective view of the fold mechanism of FIG. 7;

FIG. 9 is a partial cross-sectional view of the fold mechanism of FIG. 7 taken along line 9-9 of FIG. 7;

FIG. 10 is an enlarged cross-sectional view similar to FIG. 9 illustrating a wing pivot and related components of the fold mechanism of FIG. 7;

FIG. 11 is a cross-sectional view similar to FIG. 10 with a pin and nut of the fold mechanism shown exploded;

FIG. 12 is a cross-sectional view similar to FIG. 11 illustrating additional components of the fold mechanism exploded for clarity;

FIG. 13 is a cross-sectional view illustrating a pivot assembly in accordance with another embodiment to pivotally couple first and second components associated with a working vehicle;

FIG. 14 is a cross-sectional view illustrating a pivot assembly in accordance with yet another embodiment to pivotally couple first and second components associated with a working vehicle;

FIG. 15 is an upper perspective view illustrating a pivot assembly in accordance with still another embodiment, the pivot assembly including an illustrative fastener;

FIG. 16 is an upper perspective view of the pivot assembly of FIG. 15 with the fastener exploded for clarity; and

FIG. 17 is an enlarged cross-sectional view of the fastener of FIG. 15.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various illustrative embodiments described herein. The lack of illustration/description of such structure/components in a particular figure is, however, not to be interpreted as limiting the scope of the various embodiments in any way.

### DETAILED DESCRIPTION OF ILLUSTRATIVE EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, axial, linear, normal, tangential, etc.) in the specification and claims are to be understood as being modified in all instances by the term “about.”

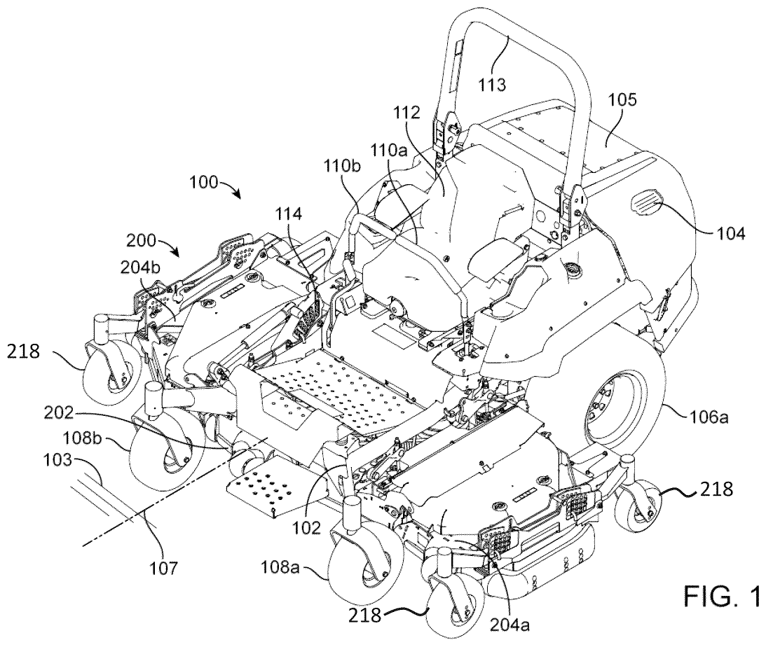

It is noted that the terms “have,” “include,” “comprise,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the mower 100 is in an operating configuration (e.g., while the mower is positioned such that wheels 106 and 108 rest upon a generally horizontal ground surface 103 as shown in FIG. 1). Additionally, use of the terms “side” or “sides” herein can refer, for example, to left and right sides, as well as to top, bottom, front, or rear sides. These terms are used only to simplify the description, however, and not to limit the interpretation of any embodiment described. In a similar manner, terms such as “first” and “second” may be used herein to describe various elements. However, such terms are provided merely to simplify identification of the element(s). Accordingly, if an element is described as “first,” there may or may not be any other subsequent elements—that is, a “second” element is not necessarily present. It is further understood that the description of any particular element as being operatively attached, connected, or coupled to another element may indicate that the elements are either directly attached, connected, or coupled to one another, or are indirectly attached, coupled, or connected to one another via intervening elements.

The suffixes “a” and “b” may be used throughout this description to denote various left-and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

Articulating mower decks include an articulating joint that provides a pivotal connection between adjacent deck sections such that each segment may better follow undulating terrain. Over the course of many mowing operations, moving parts of articulating mower decks may be subjected to uneven or premature wear, which can affect the effectiveness and service life of the moving parts and the mower deck, itself. For example, fold mechanisms of the movable deck segments-including pivot assemblies of the fold mechanisms and related components-may accumulate debris (e.g., sand, dirt, grass, etc.) during operation, which can cause uneven or premature wear on and around such moving parts. Debris accumulation, and the effects thereof, may be particularly problematic on pivot assemblies, fold mechanisms, and other moving parts closest to the ground surface. Moreover, relative movement between components of various moving parts may result in uneven or premature wear. For example, powered movement of the mower, such as over a rough or bumpy ground surface, may cause repetitive relative movement (e.g., jostling) between mower components.

An illustrative articulating mower deck is disclosed herein including a fold mechanism with improved resistance to uneven or premature wear on and around moving parts of a pivot assembly of the fold mechanism. The illustrative articulating mower deck may include a center deck section, a wing deck section, and a fold mechanism with a fold link connecting the center deck section to the wing deck section. The fold mechanism may include a first pivot assembly (e.g., a fixed pivot) connected to the center deck section and a second pivot assembly (e.g., a wing pivot) connected to the wing deck section and spaced apart from the fixed pivot. The fixed pivot may define a fixed pivot axis. Similarly, the wing pivot may define a wing pivot axis. The wing pivot may include a sleeve positioned between (e.g., between interior faces of) first and second tapered bushings associated with the wing deck section. The first and second tapered bushings may each define an at least partially frustoconical aperture having respective first and second tapered bushing taper angles. The fold mechanism still further includes a pin passing through the first and second tapered bushings and the sleeve. The pin may include a threaded first end portion, a second end portion, and a center portion. The second end portion may define a frustoconical shape having a pin taper angle corresponding to the second tapered bushing taper angle. The center portion may have a cylindrical outer diameter configured to be rotatably positioned within the sleeve. The fold mechanism may yet further include a nut configured to threadably engage the first end portion. The nut may define an at least partially frustoconical exterior surface having a nut taper angle corresponding to the first tapered bushing taper angle.

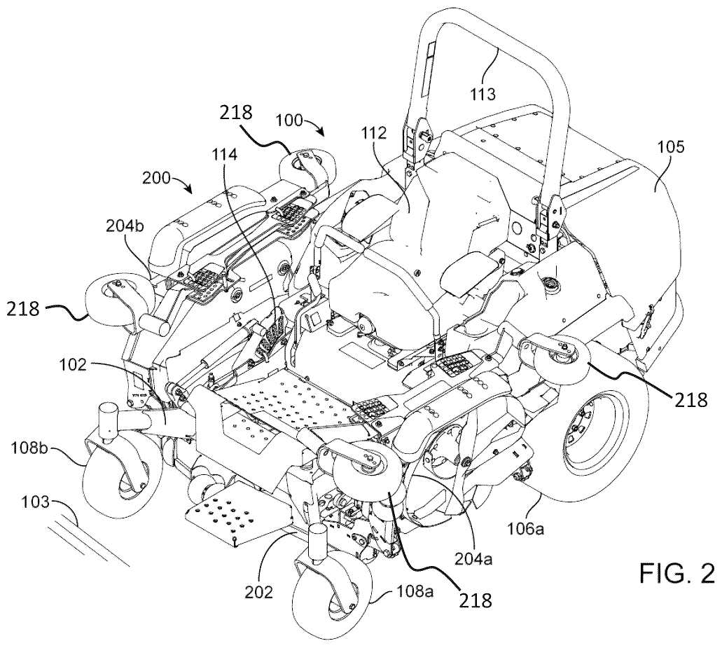

With reference to the figures of the drawing, wherein like reference numerals designate like parts and assemblies throughout the several views, FIGS. 1 and 2 show an illustrative riding grounds maintenance vehicle (e.g., the lawn mower 100) with an articulating mower deck 200 (also referred to herein as a “mower deck,” a “cutting deck,” an “articulating mower deck,” or simply as a “deck”) in accordance with embodiments of the present disclosure. While the lawn mower 100 is shown as a riding mower (e.g., a zero-turn-radius (ZTR) riding lawn mower), decks in accordance with embodiments of the present disclosure may find application to other types of mower configurations (e.g., out front, towed, etc.). Moreover, while the structure of the mower is not central to an understanding of embodiments of the present disclosure, aspects of the illustrative mower 100 are provided herein for convenience. While described herein in the context of a folding deck on such a riding mower, it is understood that fold mechanisms like those described and illustrated herein may find application to vehicles having alternative constructions and/or to devices other than mower decks.

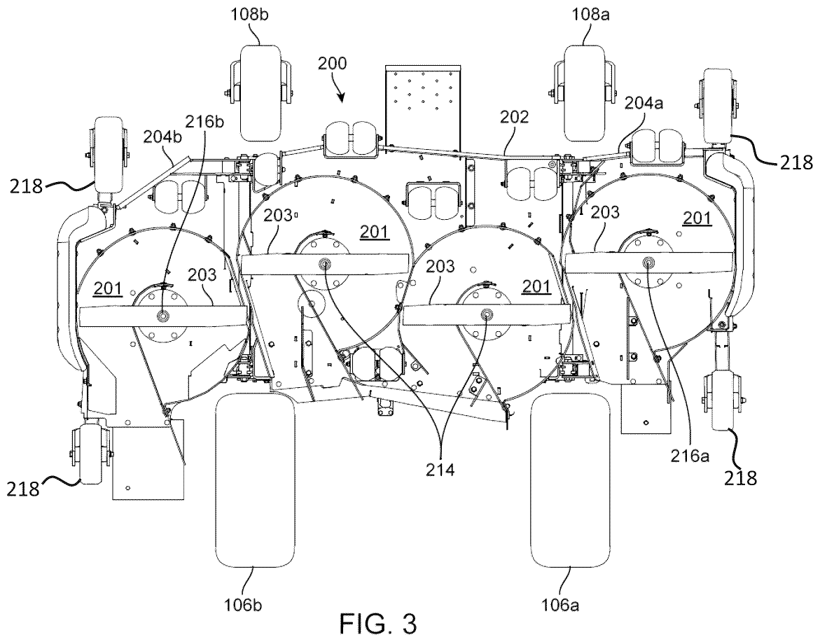

As shown in FIGS. 1 and 2, the mower 100 may include a chassis or frame 102 supporting a prime mover, e.g., electric motor or internal combustion engine 104 (which may be partially enclosed by an engine cover 105 as shown). Left and right ground engaging drive members (e.g., rear wheels 106, of which only left wheel 106a is visible in FIG. 1, but see wheel 106b in FIG. 3) may be rotatably coupled to the chassis 102 at left and right sides, respectively, near a back end of the mower 100. The drive wheels 106 may be independently powered by the engine (e.g., via one or more hydraulic motors, transaxles, transmissions, or the equivalent) so that the drive wheels 106 may selectively propel the mower 100 over the ground surface 103 during operation.

One or more controls, e.g., left and right drive control levers 110 (e.g., 110a, 110b) may also be provided. The drive control levers 110 may be pivotally coupled to the chassis 102 such that they may pivot forwardly and rearwardly, e.g., about an axis transverse to a longitudinal axis 107 (an axis extending between the front and back ends of the mower parallel to straight-ahead travel of the mower/chassis), under the control of an operator located upon an operator platform, e.g., sitting in an operator seat 112. The drive control levers 110 are operable to independently control speed and direction of their respective drive wheels 106 via manipulation of the mower's drive system as is known in the art. While illustrated herein as incorporating separate drive control levers 110, other controls (e.g., single or multiple joysticks or joystick-type levers, steering wheels, etc.) may also be used without departing from the scope of the disclosure. The mower 100 may further include various other controls (e.g., power take-off (PTO) engagement, ignition, throttle, etc.), as are known in the art. In some embodiments, a roll-over-protection system (ROPS) that includes a roll-over bar 113 may also be provided.

The illustrative mower 100 may further include one or more (e.g., a pair of) front swiveling caster wheels 108 (108a, 108b) that support a front end or portion of the mower 100 in rolling engagement with the ground surface 103. Of course, other drive configurations (e.g., actively steered front and/or rear wheels, tri-wheel configurations, front drive wheels, etc.) and vehicles using drive members other than wheels (e.g., tracks), are certainly contemplated within the scope of this disclosure.

The mower 100 may further include the articulating mower deck 200 mounted to a lower side of the chassis 102, e.g., generally between the drive wheels 106 and the caster wheels 108. The mower deck 200, which is described in more detail below, may include deck sections, each forming a deck housing defining at least one partially enclosed cutting chamber 201, as shown in FIG. 3. Within each cutting chamber 201 is one or more rotatable cutting blades 203, each attached to a rotatable blade spindle (214, 216) journalled to the respective deck housing. Once again, while illustrated herein as a belly-mount deck, other mower configurations may, alternatively or in addition, utilize other deck configurations (e.g., an out-front or rear-mounted (e.g., towed) deck). Furthermore, while illustrated herein with two single-spindle wing deck sections, other mower configurations may, alternatively or in addition, utilize other spindle configurations, such as two double-spindle wing deck sections or one single-spindle wing deck section, as just two examples.

During operation, power is selectively provided by the engine 104 to the mower deck 200 (e.g., to the spindles 214, 216) and the drive wheels 106, whereby the cutting blades rotate at a speed sufficient to sever grass and other vegetation as the deck passes over the ground surface 103. Typically, the mower deck 200 further has an operator-selectable height-of-cut control system 114 to allow deck height and/or cutting blade height adjustment relative to the ground surface 103.

With this general overview of illustrative vehicle structure, the exemplary articulating mower deck 200 is now described with continued reference to FIGS. 1 and 2. As shown in these views, the deck 200 may, in some embodiments, include a center deck section 202 and at least one wing deck section. For example, in the illustrated embodiment, the deck 200 may include left-and right-wing deck sections 204a, 204b connected to left-and right-lateral sides of the center deck section 202, respectively. The wing deck sections 204a, 204b may each move between an operating position (corresponding to the deck 200 being in an operating configuration) as shown in FIG. 1, and a folded or non-operating position (corresponding to the deck being in a folded configuration) as shown in FIG. 2. Illustrative systems and fold mechanisms adapted to enable deck folding are described in detail below. U.S. Pat. No. 11,382,263 B2 provides additional information regarding similar articulating mower decks.

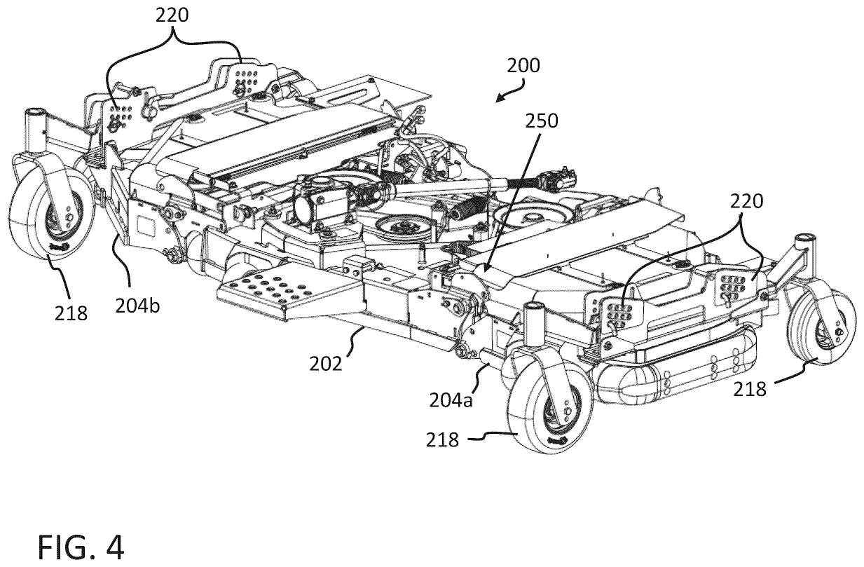

FIG. 4 illustrates the cutting deck 200 isolated from the remaining portions of the mower 100, with the deck 200 shown in the operating configuration. The center deck section 202 may be supported by the mower chassis 102 such that its elevation, relative to the ground surface 103, may be adjusted using the height of cut control system 114 (see FIG. 1). As further described below, inboard sides of the wing deck sections 204 may be pivotally supported by the center deck section 202, while outboard sides of the wing deck sections 204 may be supported, relative to the ground surface 103, by gauge wheels 218. The gauge wheels 218 may be adjustable, relative to the respective wing deck sections 204, by height adjusters 220 to adjust the minimum elevation for the wing deck sections 204.

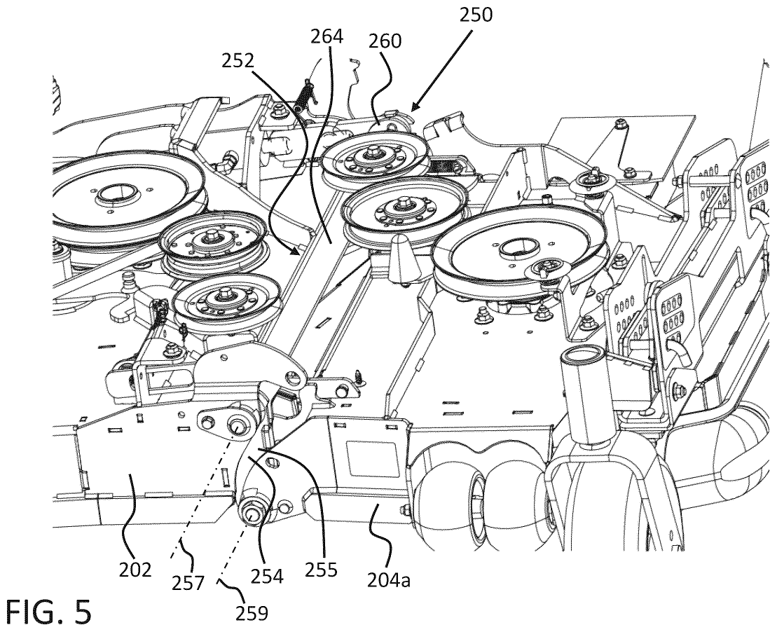

When the cutting deck 200 is not operating, the wing deck sections 204 may be moved from the operating position shown in FIGS. 1 and 4 to the folded position shown in FIG. 2 via a fold mechanism 250, an illustrative embodiment of which is partially visible in FIG. 5. The fold mechanism 250 may allow not only movement of the wing deck sections 204 between the two positions, but retention in those positions as well. While described below in the context of the fold mechanism 250 for the left-side wing deck section 204a, it is understood that the right-side wing deck section 204b utilizes, or may utilize, a similar fold mechanism.

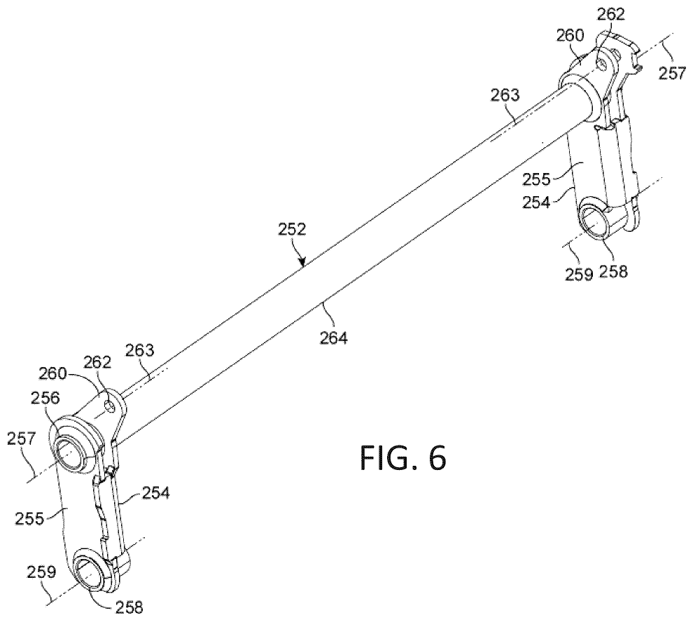

As shown in FIGS. 5 and 6 (some structure removed for clarity in these views), the fold mechanism 250 may include a fold link 252—connecting the center deck section 202 to the wing deck section 204—an embodiment of which is illustrated isolated from the deck 200 in FIG. 6. The fold link 252, in at least one embodiment, may include two bellcranks 254 each defining a deck arm 255 extending between a first pivot, or fixed pivot 256 (defining a first pivot axis, or fixed pivot axis 257), and a second pivot, or wing pivot 258 (defining a second pivot axis, or wing pivot axis 259). At least one of the bellcranks 254 may further include a lift arm 260 extending between the fixed pivot 256 and a lift arm pivot 262 (defining a lift arm pivot axis 263). A pivot tube 264 may extend between the two bellcranks 254 (e.g., along the fixed pivot axis 257), as best shown in FIG. 6. The pivot tube 264 may be welded or otherwise fixed to the two bellcranks 254 to form a unitary structure. In alternative embodiments, the pivot tube 264 and bellcranks 254 may be manufactured (e.g., cast or forged) as a single component, or fabricated using any number of components. The pivot axes 257, 259, and 263 may be offset from, and parallel to, one another such that a force applied, for example, at either lift arm pivot 262 will cause the fold link 252 to rotate about the fixed pivot 256 (i.e., about the fixed pivot axis 257) and, accordingly, pivotally displace the wing pivot 258.

The fold link 252 may generally extend from a front side of the center deck section 202 to a rear side as shown in FIG. 5 (i.e., a bellcrank 254 may be positioned near both the front and rear sides of each wing deck section). By interconnecting the two bellcranks 254 together with the pivot tube 264, uniform movement (pivoting) of the two bellcranks may result. As a result, actuating forces (i.e., to move the wing deck section 204 between the operating and folded positions) applied to one bellcrank 254 may be distributed to front and rear ends of the wing deck section as described below. However, while shown as using dual bellcranks 254 interconnected by the pivot tube 264, other embodiments may provide the desired functionality with a single bellcrank 254, thereby negating the need for the pivot tube 264.

With continued reference to FIGS. 5 and 6, the fixed pivot 256 of the fold link 252 may be journaled (e.g., pivotally connected with appropriate bearings) to the center deck section 202 such that the fold link 252 may pivot relative to the center deck section 202 about the fixed pivot axis 257. The wing deck section 204 may then be attached to the wing pivot 258 such that it may rotate, about the wing pivot axis 259, relative to the fold link 252/bellcrank 254. As a result, the fold mechanism 250 provides a dual pivot geometry that provides various benefits.

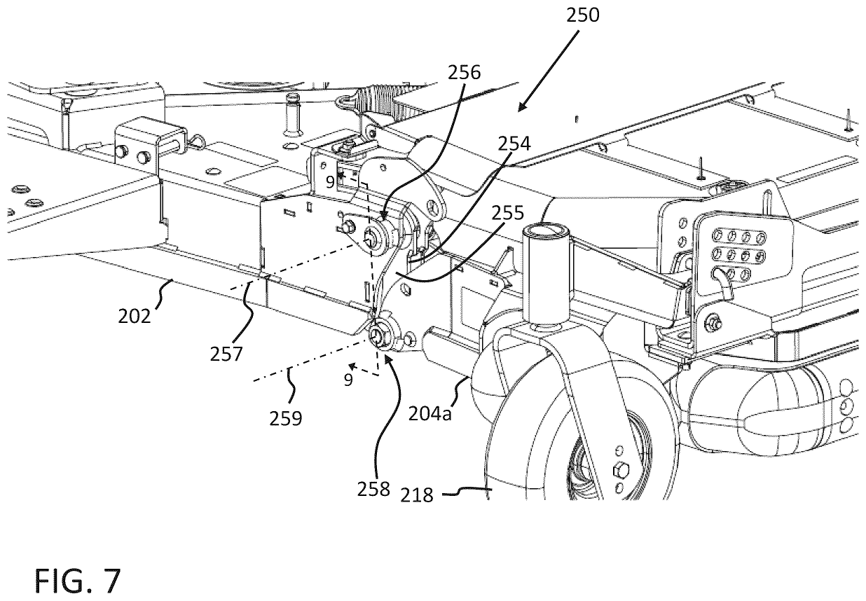

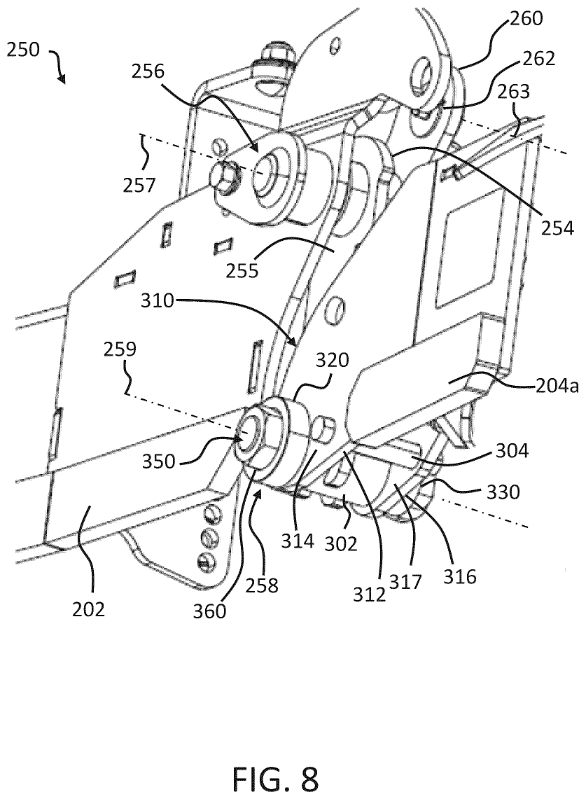

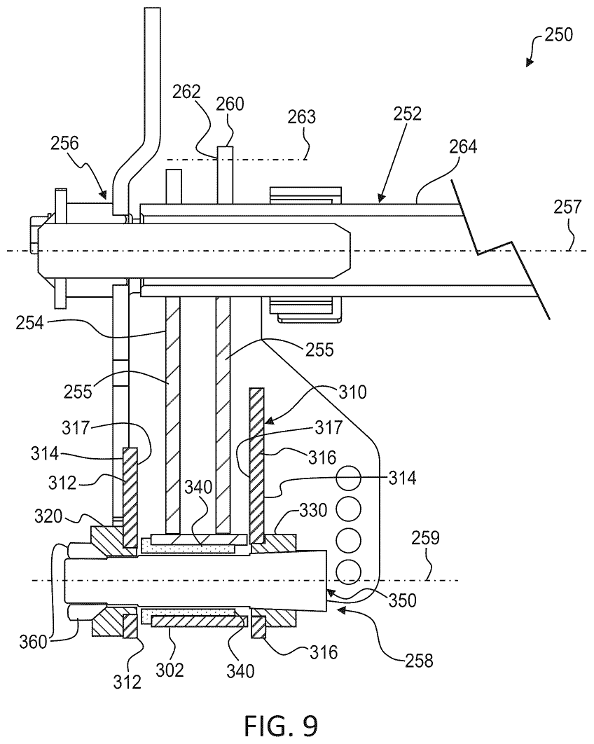

Various views of portions of the illustrative fold mechanism 250 are shown in FIG. 7 (upper perspective view), FIG. 8 (lower perspective view), and FIG. 9 (cross-sectional view taken along line 9-9 of FIG. 7). As indicated in these views, the wing pivot 258 is spaced apart from the fixed pivot 256 and includes a sleeve 302 connected to the arms 255, the sleeve 302 defining an aperture. In some embodiments, the sleeve 302 may be integrally formed with the bellcrank 254/arms 255. For example, the sleeve 302 may be welded to the bellcrank 254 or otherwise fixed to the bellcrank 254 to form a unitary structure. As another example, the sleeve 302 and bellcrank 254 may be manufactured (e.g., cast or forged) as a single component.

A sleeve (e.g., the sleeve 302) may be described as an element or member defining an aperture, or as an element defining an aperture configured to have a cylindrical element rotatably received therein, as described further herein. For example, the sleeve may include an aperture that is at least partially cylindrical. The sleeve may have any suitable outer shape, or outer surface. For example, as shown in FIG. 8, the sleeve (i.e., the sleeve 302) may be tubular with a cylindrical outer surface. As another example, the sleeve may be, or include, a rectangular prism defining an aperture. As yet another example, the sleeve may be a hexagonal prism defining an aperture. In some embodiments, the sleeve and other components (e.g., the sleeve 302 and the deck arm 255) may be manufactured (e.g., formed) as a single component. It will be understood in light of the present disclosure that the sleeve may be, or include, any suitable shape and the disclosure is not limited in this regard.

As best illustrated in FIGS. 8 and 9, the wing deck section 204 may include a clevis 310 defining a first lug 312 and a second lug 316. Each of the first and second lugs 312, 316 may define a respective aperture aligned along the wing pivot axis 259, the apertures spaced apart from one another. Each of the first and second lugs 312, 316 may have, or define, an interior face 317, wherein the interior faces 317 of the first and second lugs 312, 316 may generally be described as facing one another. Similarly, each of the first and second lugs 312, 316 may have, or define, an exterior face 314, wherein the exterior faces 314 of the first and second lugs 312, 316 may generally be described as facing in opposite directions. The sleeve 302 of the fold link 252 may be positioned between the interior faces 317 of the first and second lugs 312, 316, as best shown in FIG. 9.

The first lug 312 may also include a first tapered bushing 320, while the second lug 316 includes a second tapered bushing 330. In the illustrated embodiments, the first tapered bushing 320 is secured to the exterior face 314 of the first lug 312 (e.g., welded to or otherwise fixed to the exterior face 314 of the first lug 312). As another example, the first tapered bushing 320 and the first lug 312 may be manufactured (e.g., cast or forged) as a single component. In a similar manner, the second tapered bushing 330 may be secured to the exterior face 314 of the second lug 316. In some embodiments, the first and second tapered bushings 320, 330 may include a flange or pilot that is received within the respective apertures of the respective first and second lugs 312, 316 to, for example, assist with aligning the bushings 320, 330 with the apertures of the respective lugs 312, 316.

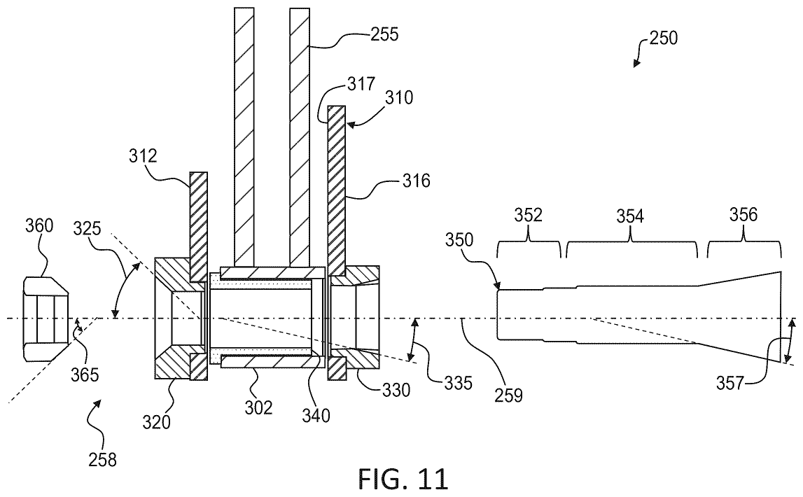

Each of the first and second tapered bushings 320, 330 defines a respective at least partially frustoconical aperture axially aligned with the respective apertures formed in the first and second lugs 312, 316 (and thus aligned with the wing pivot axis 259). The aperture of the first tapered bushing 320 may be at least partially frustoconical, having a first tapered bushing taper angle 325 (shown best in FIG. 11). In other words, the aperture of the first tapered bushing 320 may be frustoconical or may include a frustoconical surface or portion. The first tapered bushing taper angle 325 may be defined as an angle between the wing pivot axis 259 and a linear line segment lying on the frustoconical surface of the aperture of the first tapered bushing 320. Similarly, the aperture of the second tapered bushing 330 may be at least partially frustoconical, having a second tapered bushing taper angle 335 (shown best in FIG. 11). In other words, the aperture of the second tapered bushing 330 may be frustoconical or may include a frustoconical surface or portion. Like the first tapered bushing taper angle 325, the second tapered bushing taper angle 335 may be defined as an angle between the wing pivot axis 259 and a linear line segment lying on the frustoconical surface of the aperture of the second tapered bushing 330.

A tapered bushing (e.g., the first or second tapered bushing 320, 330) may be described as an element or a member defining an at least partially frustoconical aperture. Each tapered bushing may have any suitable outer shape, or outer surface. For example, and as shown in FIG. 8, the tapered bushings may each have a generally cylindrical outer surface. As another example, the tapered bushings may each be, or include, a rectangular prism defining an at least partially frustoconical aperture. As yet another example, the tapered bushings may each be a hexagonal prism defining an at least partially frustoconical aperture. In some embodiments, at least one tapered bushing and other components (e.g., the first tapered bushing 320 and the first lug 312) may be manufactured (e.g., formed) as a single component. It will be understood in light of the present disclosure that a tapered bushing may be, or include, any suitable shape and the disclosure is not limited in this regard.

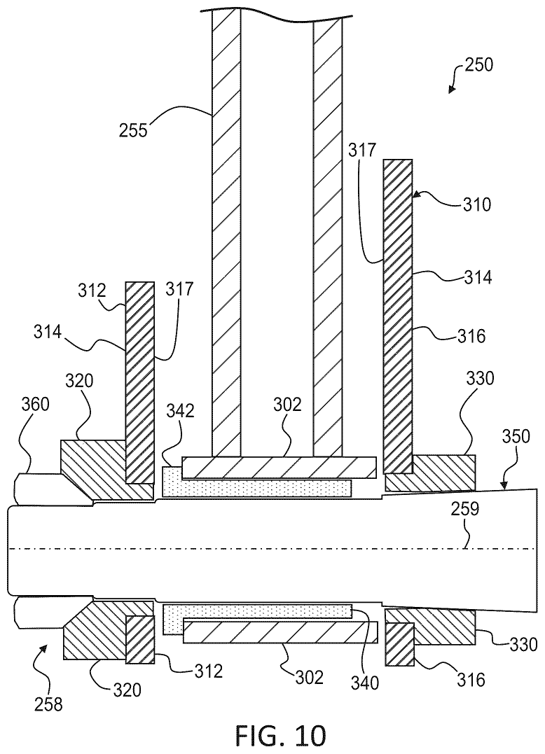

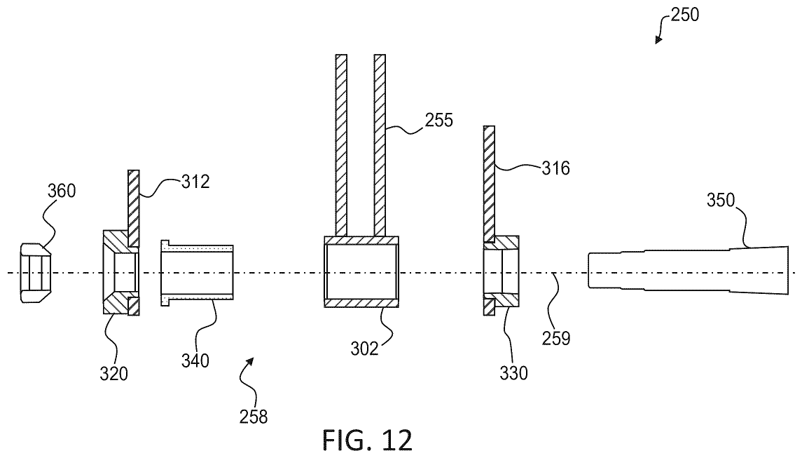

Various views of the illustrative wing pivot 258 and related components isolated from the rest of the fold mechanism 250 are shown in FIGS. 10-12, wherein FIG. 10 is a cross-sectional view of the illustrative wing pivot 258 and FIGS. 11 and 12 illustrate different exploded views of the same.

In some embodiments (see, for example, FIG. 11), the aperture of the first tapered bushing 320 may have various portions in addition to the frustoconical portion defining the first tapered bushing taper angle 325. Similarly, the aperture of the second tapered bushing 330 may have various portions in addition to the frustoconical portion defining the second tapered bushing taper angle 335. Such portions may have, for example, cylindrical surfaces, as shown in FIG. 11. As another example, such portions may have frustoconical surfaces, which may define taper angles different from the respective first and second tapered bushing taper angles 325, 335.

In one or more embodiments, and as seen in FIGS. 10-12, the wing pivot 258 of the fold mechanism 250 includes a resilient bushing 340. The resilient bushing 340 may be securely received within the sleeve 302. For example, a cylindrical outer surface of the resilient bushing 340 may define an outer diameter, which may have the same value as an inner diameter of a cylindrical inner surface of the sleeve 302, which may be desirable to secure the resilient bushing 340 within the sleeve 302 via friction or interference fit. As another example, the outer diameter of the resilient bushing 340 may have a slightly greater value (e.g., 1% greater, 5% greater, etc.) than the inner diameter of the sleeve 302. In at least one embodiment, the resilient bushing 340 is secured within the sleeve 302 using a retaining compound (e.g., LOCTITE Retaining Compound from HENKEL AG and Co. of Dusseldorf, Germany) disposed or applied between the outer surface of the resilient bushing 340 and the inner surface of the sleeve 302. In other words, the outer diameter the resilient bushing 340 may be configured to be securely received within the sleeve 302 via friction fit, a retaining compound, or other acceptable methods. In some embodiments, the resilient bushing 340 may include a flange 342 (see FIG. 10) at one end that abuts, or is configured to abut, both the sleeve 302 and the interior face 317 of the first lug 312 (or, alternatively, the interior face 317 of the second lug 316).

The resilient bushing 340 may be, or include, any suitable resilient material, such as a plastic. Suitable resilient materials may be selected based on factors such as compressibility, plasticity, material compatibility with the pin 350 (e.g., coefficient of friction between the pin 350 and the resilient material), or material compatibility with the sleeve 302 (e.g., coefficient of friction between the sleeve 302 and the resilient material). It will be understood in light of this disclosure that any suitable resilient material may be used, and the disclosure is not limited in this regard. Furthermore, suitable resilient materials may be selected based on one or more factors, such as those described herein.

In at least one embodiment, the wing pivot 258 of the fold mechanism 250 includes a pin 350 passing through, or configured to pass through, the first and second tapered bushings 320, 330, the first and second lugs 312, 316, and the resilient bushing 340. As shown particularly in FIG. 11, the pin 350 may define at least a threaded first end portion 352, a center portion 354, and a second end portion 356. The second end portion 356 may define a frustoconical surface having a pin taper angle 357. The pin taper angle 357 may be defined as an angle between the pin axis/wing pivot axis 259 and a linear line segment lying on the frustoconical surface of the second end portion 356 of the pin 350.

In one or more embodiments, the pin taper angle 357 corresponds to the second tapered bushing taper angle 335 of the second tapered bushing 330. For example, the pin taper angle 357 and the second tapered bushing taper angle 335 may have approximately the same value (e.g., the same value or nearly the same value). The pin taper angle 357 corresponding to the second tapered bushing taper angle 335 may be desirable to provide relatively greater contact area and/or force vectors between the pin 350 and the second tapered bushing 330, such that relative movement between the pin 350 and the second tapered bushing 330 is reduced or minimized. Furthermore, the pin taper angle 357 corresponding to the second tapered bushing taper angle 335 may be desirable to provide relatively greater force vectors (compared e.g., with a non-tapered joint) both axially and normal to contact surfaces between the pin 350 and the second tapered bushing 330. Improved force vectors and contact area may be desirable to reduce or minimize relative movement between the pin 350 and the second tapered bushing 330, which may reduce or minimize loosening of the joint between the pin 350 and the second tapered bushing 330, thus reducing or minimizing uneven or premature wear of the joint. In other words, the corresponding tapers advantageously focus relative movement such that relative movement occurs between the pin 350 and the sleeve 302 and/or between the pin 350 and the resilient bushing 340.

The pin taper angle 357 may have any suitable value. Suitable pin taper angles may be selected based on factors such as the value of the second tapered bushing taper angle 335, material properties (e.g., strength) of the pin 350, or material properties (e.g., strength) of the second tapered bushing 330, as a few examples. Suitable pin taper angles may include between 2 degrees and 10 degrees, for example. In one embodiment, the pin taper angle may be approximately 3.5 degrees. As further examples, suitable pin taper angles may be, or include, 1.5 degrees or greater, 2 degrees or greater, 3 degrees or greater, 5 degrees or greater, 7 degrees or greater, or 10 degrees or greater, and/or 15 degrees or less, 10 degrees or less, 7 degrees or less, 5 degrees or less, 3 degrees or less, or 2 degrees or less. In some embodiments, the pin taper angle 357 may have approximately the same value (e.g., the same value or nearly the same value) as the nut taper angle 365, described below. It will be understood in light of this disclosure that any suitable pin taper angle may be used, and the disclosure is not limited in this regard.

Similarly, the second tapered bushing taper angle 335 may have any suitable value. Suitable second tapered bushing taper angles may be selected based on factors such as the value of the pin taper angle 357, material properties (e.g., strength) of the pin 350, or material properties (e.g., strength) of the second tapered bushing 330, as a few examples. Suitable second tapered bushing taper angles may include between 2 degrees and 10 degrees, for example. In one embodiment, the second tapered bushing taper angle may be approximately 3.5 degrees. As further examples, suitable second tapered bushing taper angles may be, or include, 1.5 degrees or greater, 2 degrees or greater, 3 degrees or greater, 5 degrees or greater, 7 degrees or greater, or 10 degrees or greater, and/or 15degrees or less, 10 degrees or less, 7 degrees or less, 5 degrees or less, 3 degrees or less, or 2 degrees or less. In some embodiments, the second tapered bushing taper angle 335 may have approximately the same value (e.g., the same value or nearly the same value) as the first tapered bushing taper angle 325. It will be understood in light of this disclosure that any suitable second tapered bushing taper angle may be used, and the disclosure is not limited in this regard.

In some embodiments, the center portion 354 of the pin 350 has a cylindrical outer diameter configured to be rotatably positioned within the resilient bushing 340. For example, the outer diameter of the center portion 354 may have a value that is slightly less (e.g., 1% less, 5% less, etc.) than the inner diameter of the resilient bushing 340. In at least one embodiment, the center portion 354 of the pin 350 may be rotatable (e.g., freely rotatable) within the resilient bushing 340.

The pin 350 may be, or include, any suitable material or combination of materials, such as a metal or a metal alloy. Suitable pin materials may be selected based on factors such as strength, manufacturability, or material compatibility with the resilient bushing (e.g., coefficient of friction between the resilient bushing 340 and the pin material). In some embodiments, the pin material may be, or include, steel (e.g., 4140 steel). In some embodiments, the pin may be coated (e.g., at least partially coated) using any suitable coating, such as a wear-resistant and/or corrosion-resistant coating. Alternatively, the pin may be made of a material that provides adequate wear and/or corrosion resistance. It will be understood in light of the present disclosure that any suitable pin material or combination of materials may be used and the disclosure is not limited in this regard.

In one or more embodiments, the wing pivot of the fold mechanism 250 may also include a nut 360 configured to threadably engage the threaded first end portion 352 of the pin 350. With the pin 350 passed through (i.e., within) the first and second tapered bushings 320, 330, the first and second lugs 312, 316, and the resilient bushing 340, threading the nut 360 onto the threaded first end portion 352 may secure the pin 350 within and relative to the first and second tapered bushings 320, 330, and the first and second lugs 312, 316. In other words, tightening the nut 360 onto the threaded first end portion 352 may result in the nut 360 bearing inward against the first tapered bushing 320 and the frustoconical surface of the second end portion 356 bearing against the frustoconical surface of the second tapered bushing 330, which may minimize or reduce relative movement between each of the pin 350, the nut 360, the first and second tapered bushings 320, 330, and the first and second lugs 312, 316. In other words, with the pin 350 secured in place relative to the clevis 310, the nut 360, and the first and second tapered bushings 320, 330 via the nut 360 and the first and second tapered bushings 320, 330, the resilient bushing 340 may rotate about the pin 350, or the pin 350 may rotate within the resilient bushing 340. Moreover, with the resilient bushing 340 secured in place within the sleeve 302, as described herein, the pin 350, the first and second tapered bushings 320, 330, the clevis 310, and the nut 360 may pivot relative to the sleeve 302 and the resilient bushing 340. Thus, the wing deck section 204 may rotate, about the wing pivot axis 259, relative to the fold link 252/bellcrank 254. In some embodiments, the nut 360 may be threadably engaged/secured on the threaded first end portion 352 using a threadlocking compound or device disposed between the nut 360 and the threaded first end portion 352. Any suitable threadlocking compounds or devices may be used. Suitable threadlocking compounds or devices may include lock washers, lock nuts, jam nuts, safety wire, or adhesives (e.g., LOCTITE 243 Threadlocker from HENKEL AG and Co. of Dusseldorf, Germany), as a few examples. It will be understood in light of the present disclosure that any suitable threadlocking compounds or devices may be used and the disclosure is not limited in this regard.

In at least one embodiment, a spacer 304 (see FIG. 8) may extend between the interior faces 317 of the first and second lugs 312, 316. The spacer 304 may be configured to restrict movement (e.g., bending towards) of the first and second lugs 312, 316 relative to one another. Accordingly, the spacer 304 may restrict movement of the first and second lugs, 312, 316 relative to one another when the nut 360 is tightened onto the threaded first end portion 352 of the pin 350. While shown in FIG. 8 as elongate and cylindrical, it will be understood in light of the present disclosure that the spacer may have any suitable form or geometry.

In some embodiments, and as shown particularly in FIG. 11, the nut 360 includes a frustoconical exterior surface, or frustoconical shape, defining a nut taper angle 365. The nut taper angle 365 may be defined as an angle between the nut axis/wing pivot axis 259 and a line segment lying on the frustoconical exterior surface of the nut 360. In one or more embodiments, the nut taper angle 365 corresponds to the first tapered bushing taper angle 325 of the first tapered bushing 320. For example, the nut taper angle 365 and the first tapered bushing taper angle 325 may have the same value. As with the pin and the second bushing, the nut taper angle 365 corresponding to the first tapered bushing taper angle 325 may be desirable to provide relatively greater contact area and/or force vectors between the nut 360 and the first tapered bushing 320, such that relative movement between the nut 360 and the first tapered bushing 320 is minimized or reduced. Furthermore, the nut taper angle 365 corresponding to the first tapered bushing taper angle 325 may be desirable to provide relatively greater force vectors both axially and normal to contact surfaces between the nut 360 and the first tapered bushing 320. Improved force vectors and contact area may be desirable to reduce or minimize relative movement between the nut 360 and the first tapered bushing 320, which may reduce or minimize loosening of the joint between the nut 360 and the first tapered bushing 320, thus reducing or minimizing uneven or premature wear of the joint.

The nut taper angle 365 may have any suitable value. Suitable nut taper angles may be selected based on factors such as the value of the first tapered bushing taper angle 325, material properties (e.g., strength) of the nut 360, or material properties (e.g., strength) of the first tapered bushing 320, manufacturability, or commercial availability, as a few examples. Suitable nut taper angles may include between 10 degrees and 60 degrees, for example. In one embodiment, the nut taper angle may be approximately 45 degrees. As further examples, suitable nut taper angles may include 5 degrees or greater, 10 degrees or greater, 20 degrees or greater, 30 degrees or greater, 40 degrees or greater, 50 degrees or greater, or 60 degrees or greater, and/or 70 degrees or less, 60 degrees or less, 50 degrees or less, 40 degrees or less, 30 degrees or less, 20 degrees or less, 10 degrees or less, or 5 degrees or less. In some embodiments, the nut taper angle 365 may have approximately the same value (e.g., the same value or nearly the same value) as the pin taper angle 357. It will be understood in light of this disclosure that any suitable nut taper angle may be used, and the disclosure is not limited in this regard.

Similarly, the first tapered bushing taper angle 325 may have any suitable value. Suitable first tapered bushing taper angles may be selected based on factors such as the value of the nut taper angle 365, material properties (e.g., strength) of the nut 360, or material properties (e.g., strength) of the first tapered bushing 320, as a few examples. Suitable first tapered bushing taper angles may include between 10 degrees and 60 degrees, for example. As further examples, suitable first tapered bushing taper angles may include 5 degrees or greater, 10 degrees or greater, 20 degrees or greater, 30 degrees or greater, 40 degrees or greater, 50 degrees or greater, or 60 degrees or greater, and/or 70 degrees or less, 60 degrees or less, 50 degrees or less, 40 degrees or less, 30 degrees or less, 20 degrees or less, 10 degrees or less, or 5 degrees or less. In one embodiment, the first tapered bushing taper angle may be approximately 45 degrees. In some embodiments, the first tapered bushing taper angle 325 may have approximately the same value (e.g., the same value or nearly the same value) as the second tapered bushing taper angle 335. It will be understood in light of this disclosure that any suitable first tapered bushing taper angle may be used, and the disclosure is not limited in this regard.

Articulating mower decks in accordance with embodiments of the present disclosure may thus provide various benefits including, for example, a fold mechanism resistant to uneven and premature wear on and between the moving parts of the fold mechanism. In particular, resistance to relative movement between the pin, the first and second lugs, the first and second tapered bushings, the resilient bushing, and the nut is provided by relatively greater force vectors both axially and normal to contact surfaces between the first tapered bushing and the nut, as well as between the second tapered bushing and the pin.

While primarily described and depicted herein as part of an articulating mower deck, components of the fold mechanism disclosed herein can also be provided as a kit, for example, to retrofit an existing articulating mower deck with first and second tapered bushings (e.g., the first and second tapered bushings 320, 330), a tapered pin (e.g., the pin 350), and a fastener (e.g., the nut 360). The kit may further include a resilient bushing (e.g., the resilient bushing 340). In at least one embodiment, the kit may be configured to be installed on an articulating mower deck by securing (e.g., welding) the first and second tapered bushings on exterior faces of first and second lugs (e.g., the first and second lugs 312, 316) formed by a clevis (e.g., the clevis 310) associated with a first deck section (e.g., the wing deck section 204); positioning a sleeve (e.g., the sleeve 302) associated with a second deck section (e.g., the center deck section 202) between interior faces of the first and second lugs; passing the tapered pin through the first and second tapered bushings, the first and second lugs, and the sleeve; and securing the fastener on a first end portion (e.g., threadably securing the nut 360 on the threaded first end portion 352) of the tapered pin. In embodiments including a nut and a threaded first end region, securing the fastener on the first end portion of the tapered pin may include applying a threadlocker between the fastener and the pin. The resilient bushing may be securely received within the sleeve and disposed between (e.g., within the annular space between) the sleeve and the tapered pin. While the first and second tapered bushings shown herein (e.g., in FIGS. 10 and 11) include a pilot feature (e.g., a portion configured to be received within respective apertures of the first and second lugs), the first and second tapered bushings of the kit may lack the pilot feature. It will be understood in light of this disclosure that an articulating mower deck may be further modified for use with the retrofit kit, such as modifications to accommodate lugs with variously sized apertures.

Furthermore, while primarily described and depicted herein as pivotally coupling two portions of a mower implement (e.g., coupling center deck section 202 to wing deck section 204), various embodiments of the pivot assembly disclosed herein can also be used with other working vehicles (e.g., snow throwers, skid loaders, etc.) to pivotally couple two portions thereof, such as to couple a vehicle to an implement, to couple one portion of an implement to another portion of the implement, or to couple one implement to another implement.

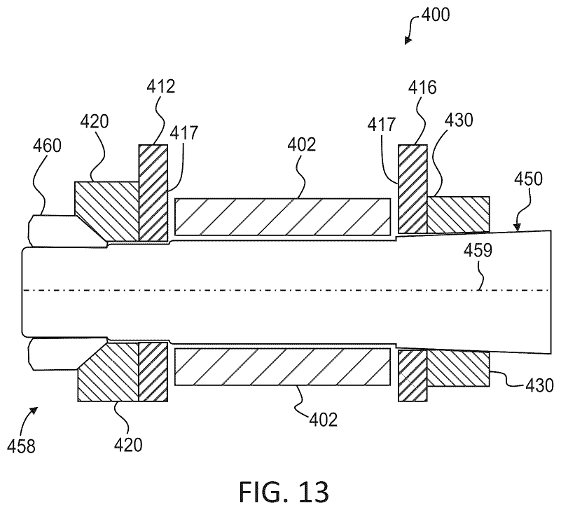

As an example, a cross-sectional view of an illustrative pivot assembly 400 to pivotally couple first and second portions of a working vehicle is shown in FIG. 13. The pivot assembly 400 may include first and second tapered bushings 420, 430 associated with a portion of the working vehicle, such as the first portion (not shown). The first and second tapered bushings 420, 430 may be secured at an external face of first and second lugs 412, 416, respectively. The first tapered bushing 420 may define an at least partially frustoconical aperture having a first tapered bushing taper angle. The second tapered bushing 430 may define an at least partially frustoconical aperture having a second tapered bushing taper angle. A pivot 458 defining a pivot axis 459 may be connected to the first portion of the working vehicle. The pivot 458 includes a sleeve 402 associated with the second portion of the working vehicle (not shown). The sleeve 402 may be positioned between interior faces 417 of the first and second lugs 412, 416.

In some embodiments, a pin 450 passes through, or is configured to pass through, the first and second tapered bushings 420, 430, the first and second lugs 412, 416, and the sleeve 402. Additionally or alternatively, the pin 450 may be disposed within the first and second tapered bushings 420, 430, the first and second lugs 412, 416, and the sleeve 402. The pin 450 may include a threaded first end portion, a second end portion, and a center portion. The second end portion may define a frustoconical shape having a pin taper angle corresponding to the second tapered bushing taper angle. The center portion of the pin 450 may have a cylindrical outer diameter configured to be rotatably positioned within the sleeve 402. A nut 460 may threadably engage, or may be configured to threadably engage, the first end portion of the pin 450. The nut 460 may define an at least partially frustoconical exterior surface having a nut taper angle corresponding to the first tapered bushing taper angle. In some embodiments, the pivot assembly 400 may include a resilient bushing (not shown in FIG. 13) between the sleeve 402 and the center portion of the pin 450.

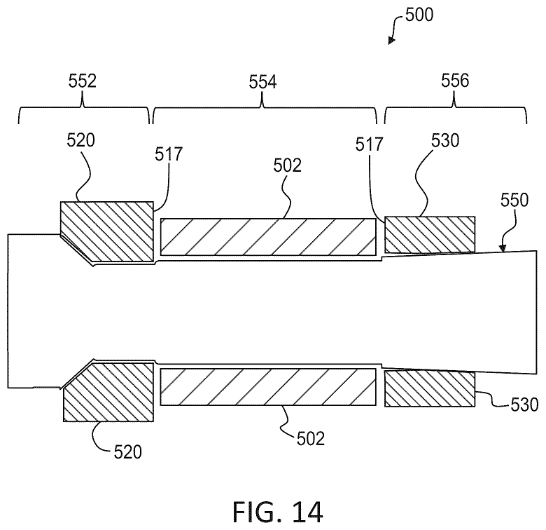

As still another example, a cross-sectional view of an illustrative pivot assembly 500 to connect first and second portions of a working vehicle (e.g., a first deck section and a second deck section of an articulating mower deck) is shown in FIG. 14. The pivot assembly 500 may include first and second tapered bushings 520, 530 associated with a portion of the working vehicle, such as the first portion (not shown). The first and second tapered bushings 520, 530 may define respective first and second at least partially frustoconical apertures having respective first and second tapered bushing taper angles. For example, the first tapered bushing 520 may define an at least partially frustoconical aperture having a first tapered bushing taper angle and the second tapered bushing 530 may define an at least partially frustoconical aperture having a second tapered bushing taper angle. A sleeve 502 associated with the second portion of the working vehicle (not shown) may be positioned between interior faces 517 of the first and second tapered bushings 520, 530 (and/or their corresponding support structure).

In one or more embodiments, a pin 550 is disposed within, or is configured to be disposed within, the first and second tapered bushings 520, 530 and the sleeve 502. The pin 550 may include a first end portion 552 and a second end portion 556. The first end portion 552 may define a first frustoconical shape having a first pin taper angle corresponding to the first tapered bushing taper angle. The second end portion 556 may define a second frustoconical shape having a second pin taper angle corresponding to the second tapered bushing taper angle. The pin 550 may be configured to compressively engage (e.g., apply an axial force along the pin axis) the first and second tapered bushings 520, 530, for example, between the first and second end portions 552, 556. The pin 550 may further include a center portion 554 between the first and second end portions 552, 556. The center portion 554 may be configured to be rotatably positioned within the sleeve 502.

Compressive engagement of the first and second tapered bushings 520, 530 between the first and second end portions 552, 556 may advantageously reduce or minimize relative movement between the pin 550 and the first and second tapered bushings 520, 530. Furthermore, the first and second pin taper angles respectively corresponding to the first and second tapered bushing taper angles may advantageously provide relatively greater force vectors both axially and normal to contact surfaces between the pin 550 and the first and second tapered bushings 520, 530, as discussed herein. Improved force vectors and contact area may advantageously reduce or minimize relative movement between the pin 550 and the first and second tapered bushings 520, 530. Each of the first and second end portions 552, 556 and the center portion 554 may be joined using any suitable method, or form. For example, one or both of the first and second end portions 552, 556 may be welded to the center portion 554 or manufactured as a single component with the center portion 554. As another example, one or more fasteners may be used to join the first and second end portions 552, 556, and the center portion 554. In some embodiments, the first end portion 552 may include a nut threadably engaged thereon, as described herein with respect to the nut 360 (FIGS. 8-12) and the nut 460 (FIG. 13).

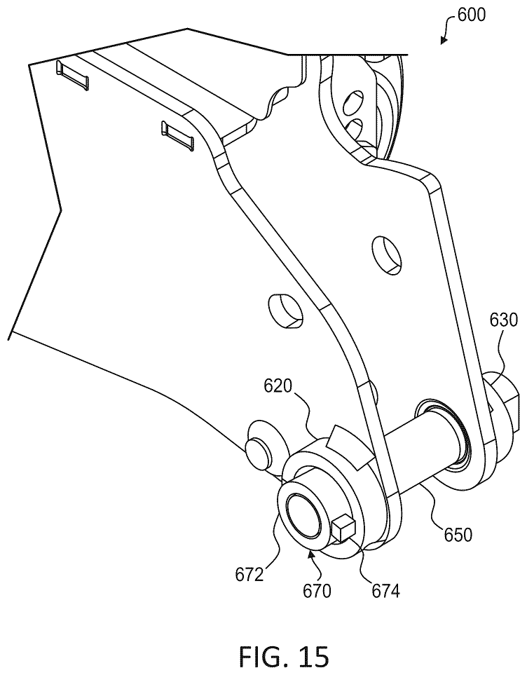

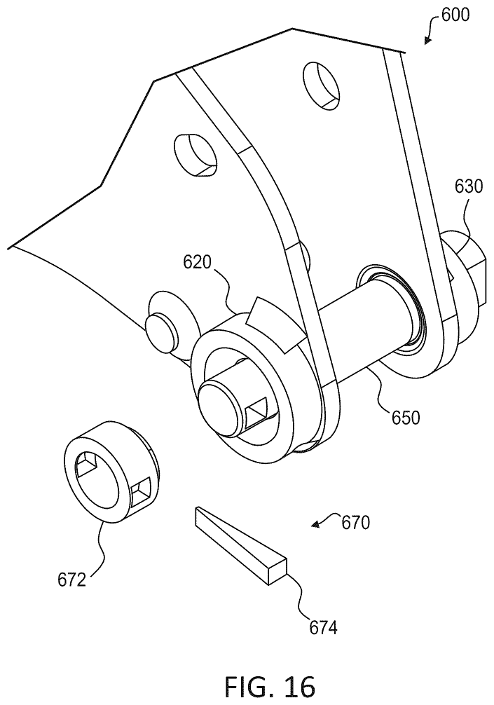

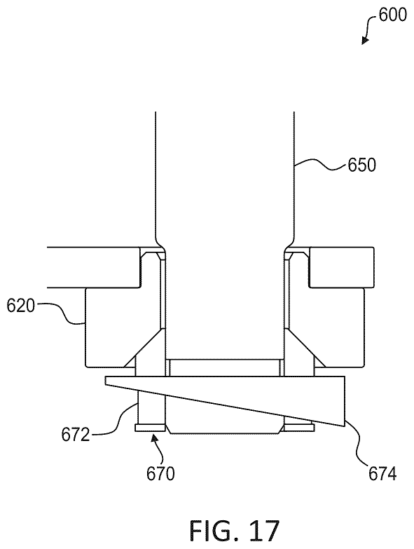

While primarily shown and described herein with a nut fastener (e.g., the nut 360) threadably engaged on a threaded first end portion (e.g., the threaded first end portion 352), any suitable fastener may be used. As an example, an illustrative pivot assembly 600 with an illustrative fastener 670 engaged on a first end portion of a pin 650 is shown in FIGS. 15-17. An upper perspective view of the illustrative pivot assembly 600 is shown in FIG. 15. An upper perspective view of the pivot assembly 600 with the fastener 670 exploded for clarity is shown in FIG. 16. An enlarged cross-sectional view of the fastener 670 is shown in FIG. 17.

In some embodiments, the pivot assembly 600 may include first and second tapered bushings 620, 630 associated with a portion of the working vehicle, such as the first portion (not shown). The first and second tapered bushings 620, 630 may define respective first and second at least partially frustoconical apertures having respective first and second tapered bushing taper angles. A sleeve associated with the second portion of the working vehicle (not shown) may be positioned between interior faces of the first and second tapered bushings 620, 630. The pin 650 may be disposed within, or may be configured to be disposed within, the first and second tapered bushings 620, 630 and the sleeve. The pin 650 may include a first end portion and a second end portion. The first end portion may define a first frustoconical shape having a first pin taper angle corresponding to the first tapered bushing taper angle. The second end portion may define a second frustoconical shape having a second pin taper angle corresponding to the second tapered bushing taper angle.

In one or more embodiments, the first end portion of the pin 650 includes the fastener 670 engaged thereon. The fastener 670 may define the first frustoconical shape having the first pin taper angle corresponding to the first tapered bushing taper angle. The fastener 670 may include a frustoconical portion defining the first frustoconical shape, such as a collar 672 defining the first frustoconical shape. The fastener 670 may further include an engagement portion configured to engage the first end portion of the pin 650. For example, as shown in FIGS. 15-17, the engagement portion may be, or include a wedge 674 or a wedge segment configured to be received by, or disposed within, corresponding apertures defined by the engagement portion (e.g., the collar 672) of the fastener 670 and the first end portion of the pin 650. As another example, the frustoconical portion of the fastener 670 may be, or include, a nut (e.g., the nut 360) and the engagement portion may be, or include, threading configured to threadably engage the first end portion of the pin (e.g., the threaded first end portion 352 of the pin 350). As still another example, the engagement portion may be, or include, a lock pin (e.g., a Cotter pin).

The complete disclosure of the patents, patent documents, and publications cited herein are incorporated by reference in their entirety as if each were individually incorporated. In the event that any inconsistency exists between the disclosure of the present application and the disclosure(s) of any document incorporated herein by reference, the disclosure of the present application shall govern.

Illustrative embodiments are described, and reference has been made to possible variations of the same. These and other variations, combinations, and modifications will be apparent to those skilled in the art, and it should be understood that the claims are not limited to the illustrative embodiments set forth herein.

What is claimed is:

1. An articulating mower deck comprising:
a first deck section;
a second deck section; and
a pivot assembly connecting the first deck section to the second deck section, the pivot assembly comprising:
first and second tapered bushings defining respective first and second at least partially frustoconical apertures having respective first and second tapered bushing taper angles, the first and second tapered bushings associated with the first deck section;
a sleeve associated with the second deck section and positioned between the first and second tapered bushings; and
a pin disposed within the first and second tapered bushings and the sleeve, the pin configured to compressively engage the first and second tapered bushings and comprising:
a first end portion defining a first frustoconical shape having a first pin taper angle corresponding to the first tapered bushing taper angle;
a second end portion defining a second frustoconical shape having a second pin taper angle corresponding to the second tapered bushing taper angle; and
a center portion between the first and second end portions configured to be rotatably positioned within the sleeve.

2. The articulating mower deck of claim 1, wherein the first end portion of the pin comprises a nut threadably engageable with a threaded end portion of the pin, wherein the first frustoconical shape having the first pin taper angle is defined by a nut taper angle of the nut.

3. The articulating mower deck of claim 2, wherein the nut taper angle is between 10 and 60 degrees.

4. The articulating mower deck of claim 2, further comprising a threadlocking compound between the nut and the threaded end portion of the pin, a threadlocking device between the nut and the threaded end portion of the pin, or a combination thereof.

5. The articulating mower deck of claim 1, wherein the second pin taper angle is between 2 and 10 degrees.

6. The articulating mower deck of claim 1, further comprising:
first and second lugs associated with the first deck section, wherein the first tapered bushing is secured to an exterior face of the first lug, and wherein the second tapered bushing is secured to an exterior face of the second lug; and
a spacer extending between interior faces of the first and second lugs, the spacer configured to restrict movement of the first and second lugs relative to one another.

7. The articulating mower deck of claim 6, further comprising a resilient bushing securely received within the sleeve and disposed within an annular space between the sleeve and the center portion of the pin.

8. The articulating mower deck of claim 7, wherein the resilient bushing comprises a flange, and wherein the resilient bushing is securely received within the sleeve such that the flange abuts both the sleeve and the interior face of the first lug.

9. The articulating mower deck of claim 7, wherein the resilient bushing comprises plastic.

10. A kit to pivotally couple a wing deck section to a center deck section of an articulating mower deck, the kit comprising:
a first tapered bushing configured to be secured at an exterior face of a first lug of the wing deck section, the first tapered bushing defining an at least partially frustoconical aperture having a first tapered bushing taper angle;
a second tapered bushing configured to be secured at an exterior face of a second lug of the wing deck section, the second tapered bushing defining an at least partially frustoconical aperture having a second tapered bushing taper angle;
a resilient bushing configured to be securely received within a sleeve of a fold link pivotally connecting the wing deck section to the center deck section;
a pin configured to pass through the first and second tapered bushings, the first and second lugs, and the resilient bushing, the pin comprising:
a threaded first end portion;
a second end portion defining a frustoconical shape having a pin taper angle corresponding to the second tapered bushing taper angle; and
a center portion having a cylindrical outer diameter configured to be rotatably positioned within the resilient bushing; and
a nut configured to threadably engage the threaded first end portion, the nut comprising an at least partially frustoconical exterior surface having a nut taper angle corresponding to the first tapered bushing taper angle.

11. The kit of claim 10, further comprising a spacer configured to extend between interior faces of the first and second lugs.

12. The kit of claim 10, wherein the resilient bushing comprises a flange, and wherein the resilient bushing is configured to be securely received within the sleeve such that the flange abuts both the sleeve and an interior face of the first lug.

13. The kit of claim 10, wherein the pin taper angle is between 2 and 10 degrees.

14. The kit of claim 10, wherein the nut taper angle is between 10 and 60 degrees.

15. The kit of claim 10, wherein the resilient bushing comprises plastic.

16. A pivot assembly to pivotally couple a first portion of a working vehicle to a second portion of the working vehicle, the pivot assembly comprising:
first and second tapered bushings defining respective first and second at least partially frustoconical apertures having respective first and second tapered bushing taper angles, the first and second tapered bushings associated with the first portion of the working vehicle;
a pivot connected to the first portion of the working vehicle, the pivot defining a pivot axis and comprising a sleeve positioned between the first and second tapered bushings, the sleeve associated with the second portion of the working vehicle;
a pin passing through the first and second tapered bushings and the sleeve, the pin comprising:
a threaded first end portion;
a second end portion defining a frustoconical shape having a pin taper angle corresponding to the second tapered bushing taper angle; and
a center portion having a cylindrical outer diameter configured to be rotatably positioned within the sleeve; and
a nut configured to threadably engage the threaded first end portion, the nut defining an at least partially frustoconical exterior surface having a nut taper angle corresponding to the first tapered bushing taper angle.

17. The pivot assembly of claim 16, further comprising a resilient bushing securely received within the sleeve and disposed within an annular space between the sleeve and the center portion of the pin.

18. The pivot assembly of claim 17, wherein the resilient bushing comprises plastic.

19. The pivot assembly of claim 17, wherein the resilient bushing comprises a flange, and wherein the resilient bushing is securely received within the sleeve such that the flange abuts the sleeve.

20. The pivot assembly of claim 17, wherein the resilient bushing is configured to be securely received within the sleeve via friction fit, a retaining compound, or a combination thereof.
